(19) United States
(12) Patent Application Publication
(10) Pub. No.: US 2026/0094028 A1
(43) Pub. Date: Apr. 2, 2026

(54) METHOD FOR PERFORMING ACCELERATION PROCEDURE TO ACCELERATE INFERENCE PROCEDURE OF LARGE LANGUAGE MODEL

(71) Applicant: MEDIATEK INC., Hsinchu City (TW)

(72) Inventors: Yue-Ting Pan, Hsinchu City (TW); Huai-Ting Li, Hsinchu City (TW); Yi-Min Tsai, Hsinchu City (TW); Ya-Lin Huang, Hsinchu City (TW); I-Lin Chen, Hsinchu City (TW)

(73) Assignee: MEDIATEK INC., Hsinchu City (TW)

(21) Appl. No.: 19/340,885

(22) Filed: Sep. 26, 2025

Related U.S. Application Data
(60) Provisional application No. 63/699,993, filed on Sep. 27, 2024.

(51) Int. Cl. G06N 5/04; G06F 40/284

(52) U.S. Cl. CPC G06N 5/04; G06F 40/284

(57) ABSTRACT

A method for performing an acceleration procedure to accelerate an inference procedure of a large language model (LLM) includes: performing a first drafting procedure to generate multiple first draft tokens; according to first draft information related to the multiple first draft tokens, determining whether a first rule is met to generate a first determination result, wherein the first rule corresponds to the first acceleration procedure; in response to the first determination result indicating that the first rule is not met, performing a second drafting procedure to generate multiple second draft tokens; obtaining multiple formal draft tokens at least based on the multiple second draft tokens; inputting the multiple formal draft tokens to the LLM in order to generate multiple target tokens; and performing a matching operation upon the multiple formal draft tokens and the multiple target tokens to generate at least one output tokens of the LLM.

### CROSS REFERENCE TO RELATED APPLICATIONS

This application claims the benefit of U.S. Provisional Application No. 63/699,993, filed on Sep. 27, 2024. The content of the application is incorporated herein by reference.

### BACKGROUND

The present invention is related to an acceleration procedure performed for accelerating an inference procedure of a large language model (LLM), and more particularly, to a method for performing the acceleration procedure.

The inference procedure of the LLM may be performed via an auto-regressive (AR) method, wherein each time the LLM is run through the AR method, a single token is generated as a part of an input prompt. The speed at which tokens are generated, however, may seriously affect the user experience. In order to address this issue, the existing acceleration procedures for speeding up the inference procedure of the LLM may include a drafter-based drafting procedure or a retrieval-based drafting procedure, wherein draft tokens generated by the drafter-based drafting procedure may be more accurate, but the generation process of the drafter-based drafting procedure is more time-consuming; and draft token generation process of the retrieval-based drafting procedure may be faster, but the generated draft tokens may be less accurate.

### SUMMARY

It is therefore one of the objectives of the present invention to provide a method for performing an acceleration procedure to accelerate an inference procedure of an LLM, and an associated non-transitory machine-readable medium, in order to address the above-mentioned issues.

According to an embodiment of the present invention, a method for performing an acceleration procedure to accelerate an inference procedure of an LLM is provided. The method comprises: performing a first drafting procedure in order to generate multiple first draft tokens; according to first draft information related to the multiple first draft tokens, determining whether a first rule is met in order to generate a first determination result, wherein the first rule corresponds to the first acceleration procedure; in response to the first determination result indicating that the first rule is not met, performing a second drafting procedure in order to generate multiple second draft tokens; obtaining multiple formal draft tokens at least based on the multiple second draft tokens; inputting the multiple formal draft tokens to the LLM in order to generate multiple target tokens; and performing a matching operation upon the multiple formal draft tokens and the multiple target tokens in order to generate at least one output tokens of the LLM.

According to an embodiment of the present invention, a non-transitory machine-readable medium for storing a program code is provided, wherein when loaded and executed by a processor, the program code instructs the processor to perform a method for performing an acceleration procedure to accelerate an inference procedure of an LLM. The method comprises: performing a first drafting procedure in order to generate multiple first draft tokens; according to first draft information related to the multiple first draft tokens, determining whether a first rule is met in order to generate a first determination result, wherein the first rule corresponds to the first acceleration procedure; in response to the first determination result indicating that the first rule is not met, performing a second drafting procedure in order to generate multiple second draft tokens; obtaining multiple formal draft tokens at least based on the multiple second draft tokens; inputting the multiple formal draft tokens to the LLM in order to generate multiple target tokens; and performing a matching operation upon the multiple formal draft tokens and the multiple target tokens in order to generate at least one output tokens of the LLM.

One of the benefits of the present invention is that, by the method of the present invention, under a condition that two drafting procedures (e.g., a retrieval-based drafting procedure and a drafter-based drafting procedure) are selectively performed, the two drafting procedures can be combined, and advantages of the two drafting procedures can also be utilized to improve the number of accepted tokens when the draft tokens are input to an LLM, and improve the generated speed of the tokens of the LLM. In addition, under the scheme of using acceleration procedures in multiple iterations, the overall performance across multiple iterations shows a further improvement on the generated speed of the tokens of the LLM.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating implementation details of a method for generating multiple draft tokens via a retrieval-based drafting procedure according to an embodiment of the present invention.

FIG. 3 is a diagram illustrating a flow chart of a method for performing an acceleration procedure to accelerate an inference procedure of an LLM according to an embodiment of the present invention.

FIG. 4 is a diagram illustrating a flow chart of a method for performing an acceleration procedure to accelerate an inference procedure of an LLM according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

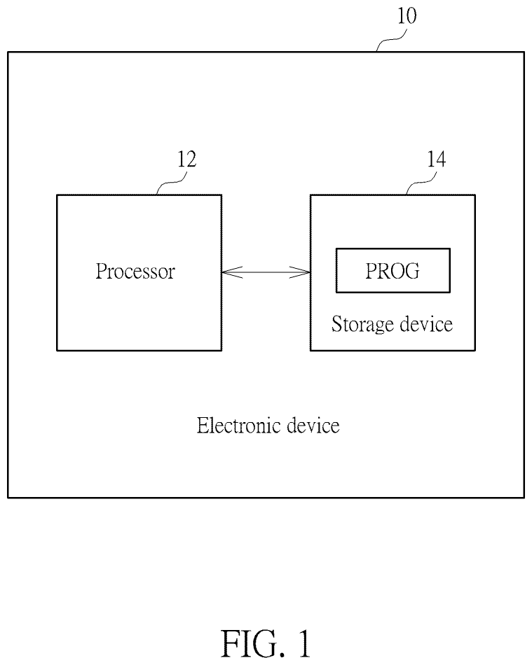

FIG. 1 is a diagram illustrating an electronic device 10 according to an embodiment of the present invention. By way of example, but not limitation, the electronic device 10 may be a portable device (e.g., a smartphone, a wearable device, and a tablet), a tablet computer, or a personal computer (e.g., a desktop computer and a laptop computer). The electronic device 10 may include a processor 12 and a storage device 14 (e.g., a memory). The processor 12 may be a single-core processor or a multi-core processor, and may be any of a neural network processing unit (NPU), a central processing unit (CPU), a tensor processing unit (TPU), and a graphics processing unit (GPU). The storage device 14 is a non-transitory machine-readable medium, and is arranged to store a computer program code PROG, wherein the computer program code PROG may include multiple algorithms.

The processor 12 is equipped with software execution capability. When loaded and executed by the processor 12, the algorithms instruct the processor 12 to perform an acceleration procedure, and the computer program code PROG instructs the processor 12 to run a large language model (LLM) L_MODEL and perform a method for performing the acceleration procedure, wherein the acceleration procedure is performed for accelerating an inference procedure of the LLM L_MODEL; and the acceleration procedure includes N drafting procedures, and “N” is an integer greater than one (i.e., N>1; for example, N=2). For example, the N drafting procedures may include a drafter-based drafting procedure (e.g., at least one of EAGLE, speculative decoding (SPD), and Medusa) and a retrieval-based drafting procedure (e.g., prompt lookup decoding (PLD)). The acceleration procedure may be divided into three steps, such as a drafting step, a parallel decoding step, and a judgment step.

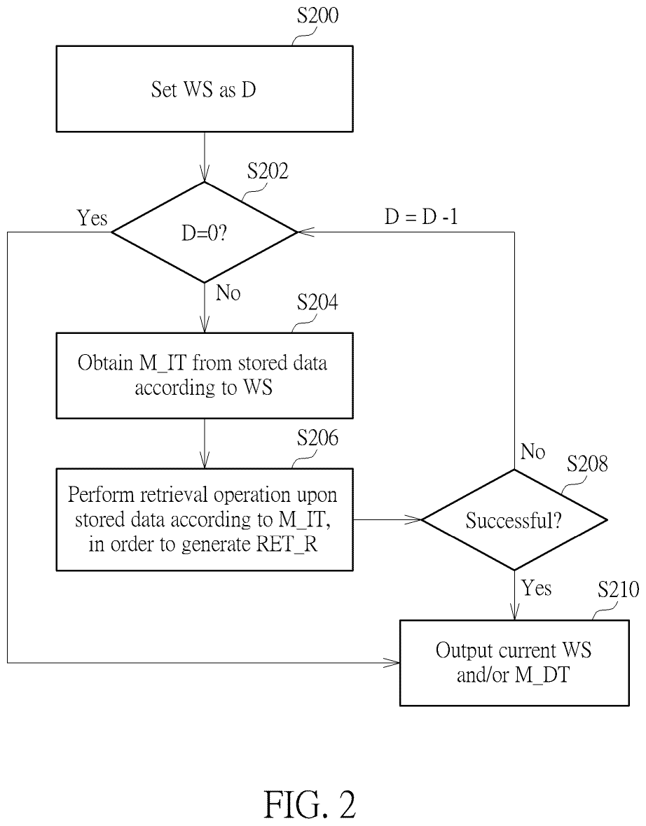

In the drafting step of the acceleration procedure, a drafting procedure (e.g., an early exit (EE) module of the LLM L_MODEL, a retrieval-based drafting procedure, or a drafter-based drafting procedure) run by the processor 12 may be utilized to perform a prediction operation according to stored data (e.g., an input prompt IN_P), in order to generate multiple draft tokens M_DT. For the retrieval-based drafting procedure, a retrieval operation may be performed upon the stored data (e.g., the input prompt IN_P) in order to generate the draft tokens M_DT. Specifically, refer to FIG. 2. FIG. 2 is a diagram illustrating implementation details of a method for generating the draft tokens M_DT via a retrieval-based drafting procedure (e.g., the PLD) according to an embodiment of the present invention. Provided that the result is substantially the same, the steps are not required to be executed in the exact order shown in FIG. 2. For example, the method shown in FIG. 2 may be employed by the electronic device 10 shown in FIG. 1 (more particularly, the processor 12). The retrieval-based drafting procedure refers to a procedure that searches for tokens in stored data (e.g., an input prompt or additional text) as draft tokens. The drafter-based drafting procedure refers to a procedure that uses a model to perform drafting.

In Step S200, a window size value WS is initially set as a value D.

In Step S202, it is determined whether the value D is equal to zero (labeled as “D=0?” in FIG. 2 for brevity). If Yes, Step S210 is entered; if No, Step S204 is entered.

In Step S204, multiple keywords (e.g., multiple input tokens M_IT) are obtained from the stored data according to the window size value WS. For example, the value D may be regarded as a length of the input tokens M_IT, and D tokens may be obtained from the stored data since the last token of the stored data, for acting as the input tokens M_IT. After each execution of the drafting procedure and the judgment step of the LLM, the tokens generated through the judgment step of the LLM will be appended to the end of the stored data. The original stored data may be the input prompt.

In Step S206, a retrieval operation is performed upon the stored data (e.g., the input prompt IN_P) according to the input tokens M_IT, in order to generate a retrieval result RET_R.

In Step S208, it is determined whether the retrieval operation is successful according to the retrieval result RET_R (labeled as “Successful?” in FIG. 2 for brevity). If Yes, Step S210 is entered. For example, in response to the retrieval result RET_R indicating that multiple tokens (e.g., a predetermined number of tokens; denoted by “tokens M_ST”) are captured from the stored data (e.g., the input prompt IN_P), it means that the retrieval operation is successful. If No, Step S202 is returned, and the value D is decremented by one for performing another retrieval operation upon the stored data (labeled as “D=D−1” in FIG. 2 for brevity), until the value D becomes zero.

In Step S210, under a condition that the retrieval operation is successful, a continuation of the tokens M_ST is regarded as the draft tokens M_DT, and both the draft tokens M_DT and the current window size value WS are output. In addition, under a condition that the value D of the window size WS is equal to zero, only the current window size value WS is output.

It should be noted that, when the retrieval operation is performed upon the stored data (e.g., the input prompt IN_P) via a longer input tokens M_IT, more accurate draft tokens M_DT may be generated by the retrieval-based drafting procedure and more generated draft tokens M_DT may be accepted by the LLM L_MODEL. That is, the greater window size value WS can lead to the higher accepted number of the LLM L_MODEL for the draft tokens M_DT (e.g., the prediction operation for the draft tokens M_DT may be more accurate).

The usage scenarios of the LLM L_MODEL may include but are not limited to: multi-turn conversation, translation, summarization, question answering, and mathematical reasoning. The retrieval-based drafting procedure (e.g., the PLD) may significantly improve the speedup of an input/output (I/O) similar task (such as the summarization task). In addition, the retrieval operation of the retrieval-based drafting procedure (e.g., the PLD) for the draft tokens M_DT is very fast. In this embodiment, the PLD is taken as an example of the retrieval-based drafting procedure, but the present invention is not limited thereto. The advantage of the drafter-based drafting procedure is that it has a significant speed increase in most of the above scenarios, but its disadvantage is that the speed for generating the draft tokens M_DT of the drafter-based drafting procedure is much slower than that of the PLD. In order to combine the advantages of the retrieval-based drafting procedure and the drafter-based drafting procedure for different usage scenarios of the LLM L_MODEL, the present invention proposes a method for performing an acceleration procedure to accelerate an inference procedure of the LLM L_MODEL by selectively performing the drafting procedures AP_1-AP_N.

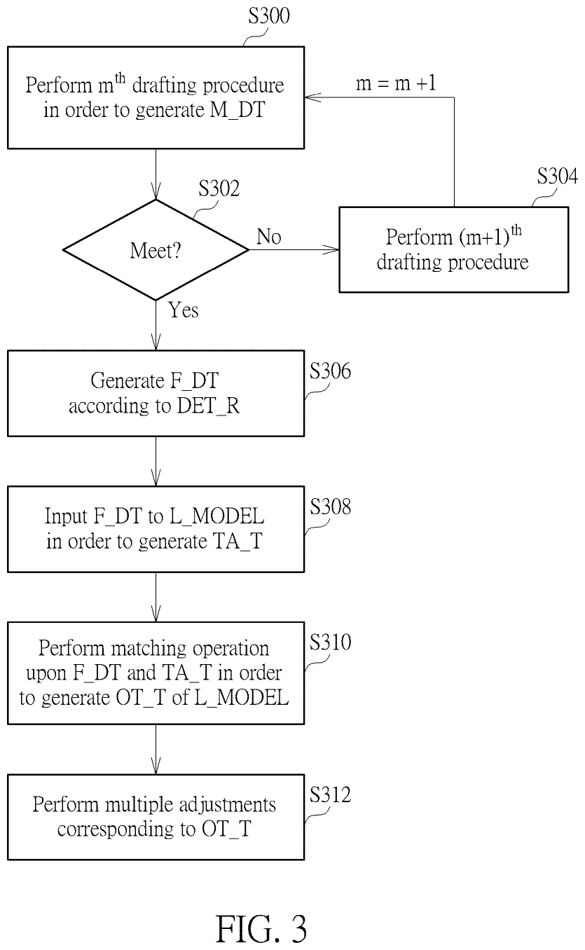

FIG. 3 is a diagram illustrating a flow chart of a method for performing an acceleration procedure to accelerate an inference procedure of the LLM L_MODEL according to an embodiment of the present invention. Provided that the result is substantially the same, the steps are not required to be executed in the exact order shown in FIG. 3. For example, the method shown in FIG. 3 may be employed by the electronic device 10 shown in FIG. 1 (more particularly, the processor 12). In this embodiment, the number of drafting procedures AP_1-AP_N is greater than two (i.e., N>2), and the drafting procedures AP_1-AP_N are different from each other. In addition, multiple rules RU_1-RU_N−1 may correspond to the drafting procedures AP_1-AP_N−1, respectively, wherein each of the rules RU_1-RU_N−1 is related to multiple draft tokens of a corresponding drafting procedure.

In Step S300, the m^{th} drafting procedure among the drafting procedures AP_1-AP_N is performed in order to generate the draft tokens M_DT, wherein “m” is an integer smaller than or equal to “N” (i.e., m≤N). Initially, the 1^{st} drafting procedure among the drafting procedures AP_1-AP_N may be performed.

In Step S302, according to draft information related to the draft tokens M_DT (denoted by “draft information DIN”), it is determined whether a corresponding rule among the rules RU_1-RU_N−1 (e.g., the m^{th} rule among the rules RU_1-RU_N−1 corresponding to the m^{th} drafting procedure) is met in order to generate a determination result DET_R (labeled as “Meet?” in FIG. 3 for brevity). If Yes, step S306 is entered; if No, Step S304 is entered. Take the retrieval-based drafting procedure (e.g., the PLD) as an example. The draft information DIN may include the window size value WS which corresponds to the draft tokens M_DT retrieved from the stored data (e.g., the input prompt IN_P), such as the window size value WS obtained from step S210 in FIG. 2. That is, the draft tokens M_DT are captured by using the window size value WS in the draft information DIN. The corresponding rule may be related to a relationship between the window size value WS and a threshold value (e.g., a threshold window size value TWS). For example, in response to the window size value WS being greater than or equal to the threshold window size value TWS (i.e., WS≥TWS), it means that the expected number of accept tokens after the draft tokens M_DT are input to the LLM L_MODEL is high, and the determination result DET_R indicates that the corresponding rule is met. In response to the window size value WS being smaller than the threshold window size value TWS (i.e., WS<TWS), it means that the expected number of accept tokens after the draft tokens M_DT are input to the LLM L_MODEL is low, and the determination result DET_R indicates that the corresponding rule is not met.

According to the determination result DET_R, the (m+1)^{th} drafting procedure among the drafting procedures AP_1-AP_N can be selectively performed. In Step S304, in response to the determination result DET_R indicates that the corresponding rule is not met, the (m+1)^{th} drafting procedure (labeled as “m=m+1” in FIG. 3 for brevity) may be performed. More particularly, the (m+1)^{th} drafting procedure may be performed in order to generate the draft tokens M_DT (i.e., Step S300 is returned, and “m” is replaced by “m+1”). According to the draft information DIN related to the draft tokens M_DT generated by the (m+1)^{th} drafting procedure, it is determined whether the (m+1)^{th} rule among the rules RU_1-RU_N−1 is met in order to generate the determination result DET_R corresponding to the (m+1)^{th} drafting procedure, wherein the (m+1)^{th} rule corresponds to the (m+1)^{th} drafting procedure. According to the determination result DET_R corresponding to the (m+1)^{th} drafting procedure, the (m+2)^{th} drafting procedure among the drafting procedures may be selectively performed, and the rest may be deduced by analogy.

It should be noted that, under a situation that the number of drafting procedures AP_1-AP_N is “N”, if the (N−1)^{th} rule corresponded to the (N−1)^{th} drafting procedure among the rules RU_1-RU_N−1 does not met, after the N^{th} drafting procedure that is the last drafting procedure is performed and the draft tokens M_DT are generated via the N^{th} drafting procedure, Step S306 is directly entered.

In Step S306, according to the determination result DET_R, multiple formal draft tokens F_DT are generated. For example, when m=1, in response to the determination result DET_R indicating that the 1^{st} rule among the rules RU_1-RU_N−1 is met, the draft tokens M_DT generated by the 1^{st} drafting procedure among the drafting procedures AP_1-AP_N may be directly utilized as the formal draft tokens F_DT. For another example, when m=k and k>1, in response to the determination result DET_R indicating that the k^{th} rule among the rules RU_1-RU_N−1 is met, the draft tokens M_DT generated by the k^{th} drafting procedure among the drafting procedures AP_1-AP_N may be directly utilized as the formal draft tokens F_DT, but the present invention is not limited thereto.

In some embodiments, in response to the determination result DET_R indicating that the 1^{st} rule, the 2^{nd} rule, . . . , and the k^{th} rule among the rules RU_1-RU_N−1 is not met, and the (k+1)^{th} rule is met, a fusion operation may be performed upon the draft tokens M_DT generated by the 1^{st} drafting procedure, the draft tokens M_DT generated by the 2^{nd} drafting procedure, . . . , and the draft tokens M_DT generated by the (k+1)^{th} drafting procedure, in order to generate the formal draft tokens F_DT. For example, under a situation that k=1, the draft tokens M_DT corresponding to the 1^{st} drafting procedure and the draft tokens M_DT corresponding to the 2^{nd} drafting procedure may be fused/combined to generate the formal draft tokens F_DT. For another example, under a situation that k=2, the draft tokens M_DT corresponding to the 1^{st} drafting procedure, the draft tokens M_DT corresponding to the 2^{nd} drafting procedure, and the draft tokens M_DT corresponding to the 3^{rd} drafting procedure may be fused/combined to generate the formal draft tokens F_DT.

In Step S308, the formal draft tokens F_DT are input to the LLM L_MODEL in order to generate multiple target tokens TA T (i.e., the parallel decoding step is performed in the LLM L_MODEL).

In Step S310, a matching operation is performed upon the formal draft tokens F_DT and the target tokens TA T in order to generate at least one output token OT_T of the LLM L_MODEL (i.e., the judgment step of the acceleration procedure). By performing the method proposed by the present invention, the at least one output token OT_T may be promptly generated via running the LLM L_MODEL once, for speeding up the inference procedure of the LLM L_MODEL.

In Step S312, multiple adjustments corresponding to the at least one output token OT_T may be performed. For example, a sampling/updating operation may be performed upon the at least one output token OT_T, and a key value (KV) cache may be adjusted.

It should be noted that, since the parallel decoding step, the judgment step, and associated adjustments of the acceleration procedure are well known to those skilled in the art, and the focus of the present invention is on the drafting step, further descriptions are omitted here for brevity.

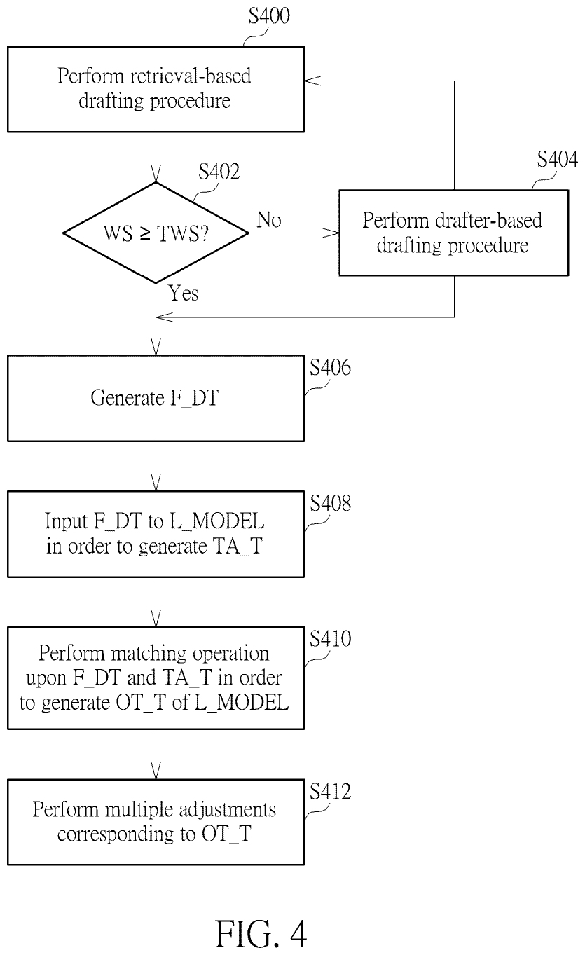

FIG. 4 is a diagram illustrating a flow chart of a method for performing an acceleration procedure to accelerate an inference procedure of the LLM L_MODEL according to another embodiment of the present invention. Provided that the result is substantially the same, the steps are not required to be executed in the exact order shown in FIG. 4. For example, the method shown in FIG. 4 may be employed by the electronic device 10 shown in FIG. 1 (more particularly, the processor 12). In this embodiment, the drafting procedure performed first is a drafting procedure that can promptly generate the draft tokens M_DT (e.g., the retrieval-based drafting procedure, such as the PLD), and the selectively performed drafting procedure is the drafter-based drafting procedure (e.g., the Medusa), but the present invention is not limited thereto. In some embodiments, the drafting procedure performed first may be the drafter-based drafting procedure.

In Step S400, a retrieval-based drafting procedure (e.g., the PLD) is performed in order to generate the draft tokens M_DT.

In Step S402, it is determined whether the window size value WS corresponding to the draft tokens M_DT being retrieved from the stored data (e.g., the input prompt IN_P) (e.g., the window size value WS obtained from step S210 in FIG. 2) is greater than or equal to the threshold window size value TWS (i.e., WS≥TWS), for selectively performing the drafter-based drafting procedure (e.g., the Medusa). If Yes, Step S406 is entered; if No, Step S404 is entered.

In Step S404, the drafter-based drafting procedure (e.g., the Medusa) is performed in order to generate the draft tokens M_DT.

In Step S406, according to the draft tokens M_DT corresponding to the retrieval-based drafting procedure (e.g., the PLD) and/or the draft tokens M_DT corresponding to the drafter-based drafting procedure (e.g., the Medusa), the formal draft tokens F_DT are generated. Specifically, if the window size value WS is greater than or equal to the threshold window size value TWS and the drafter-based drafting procedure (e.g., the Medusa) is not performed, the draft tokens M_DT corresponding to the retrieval-based drafting procedure (e.g., the PLD) are directly utilized as the formal draft tokens F_DT. If the window size value WS is less than the threshold window size value TWS and the drafter-based drafting procedure (e.g., the Medusa) is performed, the draft tokens M_DT corresponding to the drafter-based drafting procedure (e.g., the Medusa) may be directly utilized as the formal draft tokens F_DT. In one embodiment, if the window size value WS is less than the threshold window size value TWS and the drafter-based drafting procedure (e.g., the Medusa) is performed, the draft tokens corresponding to the retrieval-based drafting procedure and the draft tokens corresponding to the drafter-based drafting procedure may be fused/combined to generate the formal draft tokens F_DT.

In Step S408, the formal draft tokens F_DT are input to the LLM L_MODEL in order to generate the target tokens TA T (i.e., the parallel decoding step of the acceleration procedure).

In Step S410, a matching operation is performed upon the formal draft tokens F_DT and the target tokens TA T in order to generate at least one output token OT_T of the LLM L_MODEL (i.e., the judgment step of the acceleration procedure).

In Step S412, multiple adjustments corresponding to the at least one output token OT_T may be performed. For example, a sampling/updating operation may be performed upon the at least one output token OT_T, and a KV cache may be adjusted. Since the operations of Steps S408-S412 are similar to that of Steps S308-S312 shown in FIG. 3, further descriptions are not repeated in detail here for brevity.

In summary, by the method of the present invention, under a condition that two drafting procedures (e.g., a retrieval-based drafting procedure and a drafter-based drafting procedure) are selectively performed, the two drafting procedures can be combined, and advantages of the two drafting procedures can also be utilized to improve the number of accepted tokens when the draft tokens are input to an LLM, and improve the generated speed of the tokens of the LLM. In addition, under the scheme of using acceleration procedures in multiple iterations, the overall performance across multiple iterations shows a further improvement on the generated speed of the tokens of the LLM.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing an acceleration procedure to accelerate an inference procedure of a large language model (LLM) comprising:
performing a first drafting procedure to generate multiple first draft tokens;
according to first draft information related to the multiple first draft tokens, determining whether a first rule is met in order to generate a first determination result, wherein the first rule corresponds to the first acceleration procedure;
in response to the first determination result indicating that the first rule is not met, performing a second drafting procedure to generate multiple second draft tokens;
obtaining multiple formal draft tokens at least based on the multiple second draft tokens;
inputting the multiple formal draft tokens to the LLM in order to generate multiple target tokens; and
performing a matching operation upon the multiple formal draft tokens and the multiple target tokens to generate at least one output token of the LLM.

2. The method of claim 1, further comprising:
in response to the first determination result indicating that the first rule is met, obtaining the multiple formal draft tokens based on the multiple first draft tokens.

3. The method of claim 2, wherein the step of obtaining the multiple formal draft tokens based on the multiple first draft tokens comprises:
utilizing the multiple first draft tokens as the multiple formal draft tokens.

4. The method of claim 1, wherein the first drafting procedure is a retrieval-based drafting procedure, and the second drafting procedure is a drafter-based drafting procedure.

5. The method of claim 1, wherein the first draft information comprises a window size value corresponding to the multiple first draft tokens retrieved from stored data; and the first rule is related to a relationship between the window size value and a threshold value.

6. The method of claim 5, wherein in response to the window size value being greater than or equal to the threshold value, the first determination result indicates that the first rule is met.

7. The method of claim 1, wherein the step of obtaining the multiple formal draft tokens at least based on the multiple second draft tokens comprises:
utilizing the multiple second draft tokens as the multiple formal draft tokens.

8. The method of claim 1, wherein the step of obtaining the multiple formal draft tokens at least based on the multiple second draft tokens comprises:
performing a fusion operation upon the multiple first draft tokens and the multiple second draft tokens to generate the multiple formal draft tokens.

9. The method of claim 1, further comprising:
according to second draft information related to the multiple second draft tokens, determining whether a second rule is met in order to generate a second determination result, wherein the second rule corresponds to the second drafting procedure;
wherein the multiple formal draft tokens are obtained at least based on the multiple second draft tokens in response to the second determination result indicating that the second rule is met.

10. The method of claim 9, further comprising:
in response to the second determination result indicating that the second rule is not met, performing a third drafting procedure to generate multiple third draft tokens; and
obtaining the multiple formal draft tokens at least based on the multiple third draft tokens.

11. A non-transitory machine-readable medium for storing a program code, wherein when loaded and executed by a processor, the program code instructs the processor to perform a method for performing an acceleration procedure to accelerate an inference procedure of a large language model (LLM); and the method comprises:
performing a first drafting procedure to generate multiple first draft tokens;
according to first draft information related to the multiple first draft tokens, determining whether a first rule is met in order to generate a first determination result, wherein the first rule corresponds to the first acceleration procedure;
in response to the first determination result indicating that the first rule is not met, performing a second drafting procedure to generate multiple second draft tokens;
obtaining multiple formal draft tokens at least based on the multiple second draft tokens;
inputting the multiple formal draft tokens to the LLM in order to generate multiple target tokens; and
performing a matching operation upon the multiple formal draft tokens and the multiple target tokens to generate at least one output token of the LLM.

12. The non-transitory machine-readable medium of claim 11, wherein the method further comprises:
in response to the first determination result indicating that the first rule is met, obtaining the multiple formal draft tokens based on the multiple first draft tokens.

13. The non-transitory machine-readable medium of claim 12, wherein the step of obtaining the multiple formal draft tokens based on the multiple first draft tokens comprises:
utilizing the multiple first draft tokens as the multiple formal draft tokens.

14. The non-transitory machine-readable medium of claim 11, wherein the first drafting procedure is a retrieval-based drafting procedure, and the second drafting procedure is a drafter-based drafting procedure.

15. The non-transitory machine-readable medium of claim 11, wherein the first draft information comprises a window size value corresponding to the multiple first draft tokens retrieved from stored data; and the first rule is related to a relationship between the window size value and a threshold value.

16. The non-transitory machine-readable medium of claim 15, wherein in response to the window size value being greater than or equal to the threshold value, the first determination result indicates that the first rule is met.

17. The non-transitory machine-readable medium of claim 11, wherein the step of obtaining the multiple formal draft tokens at least based on the multiple second draft tokens comprises:
utilizing the multiple second draft tokens as the multiple formal draft tokens.

18. The non-transitory machine-readable medium of claim 11, wherein the step of obtaining the multiple formal draft tokens at least based on the multiple second draft tokens comprises:
performing a fusion operation upon the multiple first draft tokens and the multiple second draft tokens to generate the multiple formal draft tokens.

19. The non-transitory machine-readable medium of claim 11, wherein the method further comprises:
according to second draft information related to the multiple second draft tokens, determining whether a second rule is met in order to generate a second determination result, wherein the second rule corresponds to the second drafting procedure;
wherein the multiple formal draft tokens are obtained at least based on the multiple second draft tokens in response to the second determination result indicating that the second rule is met.

20. The non-transitory machine-readable medium of claim 19, wherein the method further comprises:
in response to the second determination result indicating that the second rule is not met, performing a third drafting procedure in order to generate multiple third draft tokens; and
obtaining the multiple formal draft tokens at least based on the multiple third draft tokens.
